(19) United States
(12) Patent Application Publication
(10) Pub. No.: US 2018/0092096 A1
(43) Pub. Date: Mar. 29, 2018

(54) RELAY DEVICE AND METHOD OF WIRELESS COMMUNICATION

(71) Applicant: FUJITSU LIMITED, Kawasaki-shi (JP)

(72) Inventor: Hitoshi YOKOYAMA, Shinagawa (JP)

(73) Assignee: FUJITSU LIMITED, Kawasaki-shi (JP)

(21) Appl. No.: 15/668,289

(22) Filed: Aug. 3, 2017

(30) Foreign Application Priority Data
Sep. 23, 2016 (JP) 2016-186118

(51) Int. Cl. H04W 72/04; H04B 7/155; H04L 5/00

(52) U.S. Cl. CPC H04W 72/0453; H04W 72/042; H04L 5/0098; H04B 7/155

(57) ABSTRACT

A relay device configured to perform wireless communication with a base station device and a terminal device, and to relay data transmission between the base station device and the terminal device, the relay device includes a memory, and a processor coupled to the memory and configured to obtain first information indicating a first communication speed in the wireless communication between the base station device and the relay device and a second communication speed in the wireless communication between the relay device and the terminal device, and control a number of carriers to be used in the wireless communication between the relay device and the terminal device based on the first information so that the number of carriers is increased when the first communication speed is greater than the second communication speed, and the number of carriers is decreased when the second communication speed is greater than the first communication speed.

### CROSS-REFERENCE TO RELATED APPLICATION

This application is based upon and claims the benefit of priority of the prior Japanese Patent Application No. 2016-186118, filed on Sep. 23, 2016, the entire contents of which are incorporated herein by reference.

### FIELD

The embodiments discussed herein are related to a relay device and a method of wireless communication.

### BACKGROUND

In recent years, many terminal devices such as smartphones or tablet terminals have a wireless relay function. The wireless relay function is a function of relaying wireless communication between a base station device and a terminal device in a wireless communication system. For example, a device (hereinafter, referred to as a wireless relay device) having the wireless relay function is disposed on an edge of a communication area of the base station device, and thus, an area in which the terminal device is able to communicate expands.

As a first function of the wireless relay function, there is a tethering function using wireless fidelity (Wi-Fi) communication. In this case, the terminal device is wirelessly coupled with the wireless relay device through Wi-Fi, and the wireless relay device is coupled with the base station device via a public communication network such as Long Term Evolution (LTE) or LTE-Advance (LTE-A). Thus, the wireless communication of the terminal device is relayed.

As a second function of the wireless relay function, there is a relay function using device-to-device (D2D) coupling. In this case, the terminal device performs the D2D coupling with the wireless relay device through the same LTE or LTE-A as the public communication network, and thus, the wireless relay device relays the wireless communication of the terminal device.

In both the wireless relay functions, wireless resources of a plurality of predetermined frequency bands are used in the communication between the terminal device and the wireless relay device, and thus, high-speed communication is achieved. Examples of the related art include Japanese Laid-open Patent Publication Nos. 2014-107783 and 2015-198446.

### SUMMARY

According to an aspect of the invention, a relay device configured to perform wireless communication with a base station device and a terminal device, and to relay data transmission between the base station device and the terminal device, the relay device includes a memory, and a processor coupled to the memory and configured to obtain first information indicating a first communication speed in the wireless communication between the base station device and the relay device and a second communication speed in the wireless communication between the relay device and the terminal device, and control a number of carriers to be used in the wireless communication between the relay device and the terminal device based on the first information so that the number of carriers is increased when the first communication speed is greater than the second communication speed, and the number of carriers is decreased when the second communication speed is greater than the first communication speed.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a configuration example of a communication system 10.

FIG. 2 is a diagram illustrating an example of a sequence of a relay process in a case where a terminal device 100 and a wireless relay device 300 of the communication system 10 perform D2D communication.

FIG. 3 is a diagram illustrating a configuration example of the wireless relay device 300.

FIG. 4 is a diagram illustrating a configuration example of the terminal device 100.

FIG. 5 is a diagram illustrating a configuration example of the base station device 200.

FIG. 6 is a diagram illustrating an example of a sequence of a carrier number change process of the communication system 10.

FIG. 7 is a diagram illustrating an example of a process flowchart of a communication information acquisition process S204.

FIG. 8 is a diagram illustrating an example of a process flowchart of a carrier determination process S205.

FIG. 9 is a diagram illustrating an example in a case where the number of carriers is increased.

FIG. 10 is a diagram illustrating an example of a measurement value and an estimation value of a communication speed for each carrier number.

FIG. 11 is a diagram illustrating an example in which the number of carriers is decreased.

FIG. 12 is a diagram illustrating an example of a measurement value and an estimation value of the communication speed for each carrier number.

FIG. 13 is a diagram illustrating an example of a process flowchart of a communication information acquisition process S204 according to the second embodiment.

FIG. 14 is a diagram illustrating an example of a process flowchart of a carrier determination process S205 according to the second embodiment.

FIG. 15 is a diagram illustrating an example of a process flowchart of an index determination process.

FIG. 16 is a diagram illustrating an example of uplink and downlink communication speeds.

FIG. 17 is a diagram illustrating an example of the control of uplink and downlink buffers of the wireless relay device 300.

FIG. 18 is a diagram illustrating an example of a process flowchart of a communication information acquisition process S204 according to a third embodiment.

FIG. 19 is a diagram illustrating an example of a process flowchart of a carrier determination process S205 according to the third embodiment.

FIG. 20 is a diagram illustrating an example in a case where a downlink data retention ratio is equal or greater than a downlink threshold and an uplink data retention ratio is less than an uplink threshold.

FIG. 21 is a diagram illustrating an example in a case where the downlink data retention ratio is less than the downlink threshold and the uplink data retention ratio is equal or greater than the uplink threshold.

FIG. 22 is a diagram illustrating an example in a case where the downlink data retention ratio is equal or greater than the downlink threshold and the uplink data retention ratio is equal or greater than the uplink threshold.

FIG. 23 is a diagram illustrating an example of a process flowchart of the carrier determination process S205.

### DESCRIPTION OF EMBODIMENTS

There are some cases where wireless resources of a plurality of frequency bands between a wireless relay device and a terminal device are not efficiently used. For example, there are some cases where since a small amount of data is able to transmitted and received between a base station device and the wireless relay device and wireless resources of supernumerary frequency bands in data transmission are used, the wireless resources are not effectively used. For example, there are some cases where since a large amount of data is able to be transmitted and received between the base station device and the wireless relay device and the number of wireless resources to be used in communication is small, the large amount of data is not able to be transmitted and received without delay.

### First Embodiment

<Configuration Example of Communication System>

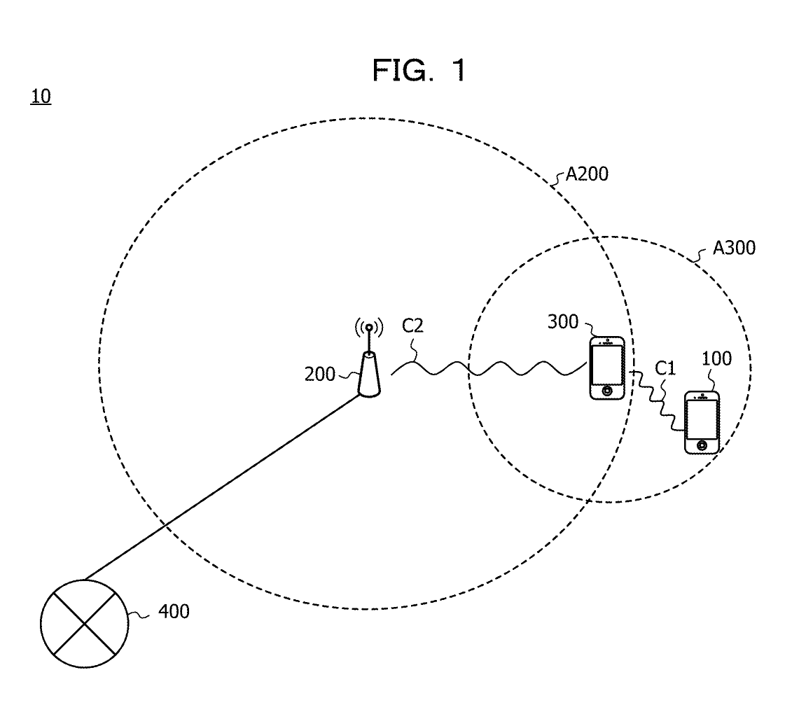

FIG. 1 is a diagram illustrating a configuration example of a communication system 10. The communication system 10 includes a terminal device 100, a base station device 200, a wireless relay device 300, and an external network 400. For example, the terminal device 100 and the wireless relay device 300 are mobile communication devices such as tablet terminals or smartphones. For example, the base station device 200 is fixed in a fixed position by an administrator of the communication system 10.

The terminal device 100 and the wireless relay device 300 are wirelessly coupled, and the base station device 200 and the wireless relay device 300 are wirelessly coupled. For example, communication C2 between the base station device 200 and the wireless relay device 300 is wireless communication conformable to a standard such as LTE. For example, communication C1 between the wireless relay device 300 and the terminal device 100 may be a local area network such as Wi-Fi or D2D communication in which communication conformable to a communication standard such as LTE without passing through the base station device is performed.

For example, the base station device 200 is coupled with the external network 400 through a gateway or a base station control device. An area A200 is a communication area where the terminal device is able to perform wireless communication with the base station device 200, and an area A300 is a communication area where the terminal device is able to perform wireless communication with the wireless relay device 300.

For example, in the communication system 10, the terminal device 100 is able to perform data communication with the external network 400, and is wirelessly coupled with the wireless relay device 300 without being directly and wirelessly coupled with the base station device 200. The terminal device 100 communicates with the base station device 200 through the wireless relay device 300, and realizes data communication with the external network 400. In so doing, as illustrated in FIG. 1, even through the terminal device 100 is present out of a coverage of the communication area A200 of the base station device 200, the terminal device 100 is able to communicate with the base station device 200 through the wireless relay device 300.

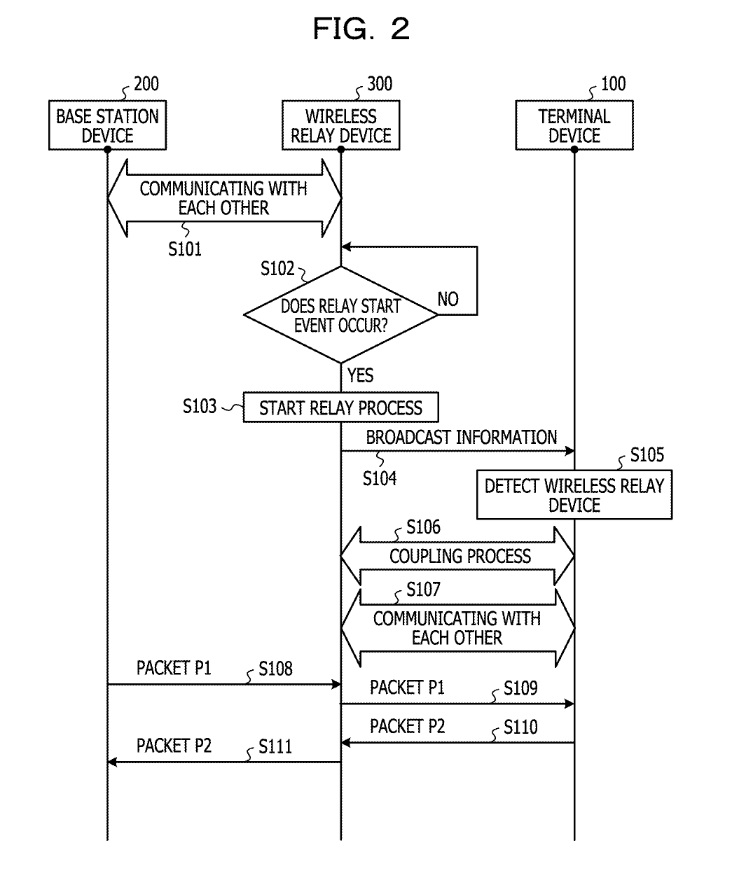

FIG. 2 is a diagram illustrating an example of a sequence of a relay process in a case where the terminal device 100 and the wireless relay device 300 of the communication system 10 perform D2D communication. The wireless relay device 300 positioned within the communication area A200 of the base station device 200 is wirelessly communicating with the base station device 200 (S101). Wireless resources to be used in the communication between the base station device 200 and the wireless relay device 300 are determined by the base station device 200. There are some cases where the base station device 200 is wirelessly coupled with a terminal device other than the terminal device 100 and a wireless relay device other than the wireless relay device 300 which are positioned within the communication area A200. For example, the base station device 200 determines the wireless resources to be used in the communication with the wireless relay device 300 based on wireless resources allocated with the device other than the wireless relay device 300 wirelessly coupled with the base station device or a degree of interference by radio waves in the vicinity of the base station device 200.

The wireless relay device 300 monitors whether or not a relay start event when the relay process of the communication between the terminal device 100 and the base station device 200 is started occurs (S102). For example, the relay start event may occur when a relay process program is activated by an operation of a system administrator of the communication system 10 or a user of the wireless relay device 300 who operates the wireless relay device 300. The relay start event may occur when the wireless relay device 300 is positioned on or moves to an area edge of the communication area A200. For example, the wireless relay device 300 measures a received power of the radio wave transmitted from the base station device 200, and detects that the wireless relay device is positioned on the area edge of the communication area A200 in a case where the measured received power is equal to or less than a predetermined value.

If the relay start event is detected (Yes in S102), the wireless relay device 300 starts the relay process (S103). In the relay process, the wireless relay device 300 operates as the base station device for the surrounding terminal devices. The wireless relay device 300 transmits broadcast information in a predetermined frequency band (S104). For example, the broadcast information includes an identifier of the wireless relay device 300. For example, the broadcast information is a synchronization signal such as sidelink synchronization signals (SSSs) in D2D or messages such as physical sidelink broadcast channel (PSBCH) transmitted through broadcasting.

The terminal device 100 searches for a predetermined frequency, and if the broadcast information is received (S104), the terminal device detects the wireless relay device 300 (S105). A coupling process is performed between the terminal device 100 and the wireless relay device 300 (S106), and thus, the terminal device and the wireless relay device are communicating with each other (S107).

As the relay process, if a packet P1 to be transmitted to the terminal device 100 is received from the base station device 200 (S108), the wireless relay device 300 transmits the received packet P1 to the terminal device 100 (S109). As the relay process, if a packet P2 to be transmitted to the base station device 200 is received from the terminal device 100 (S110), the wireless relay device 300 transmits the received packet P2 to the base station device 200 (S111).

As stated above, the wireless relay device 300 relays the communication between the terminal device 100 and the base station device 200. For example, the wireless relay device 300 regularly changes a frequency bandwidth to be used in the communication between the wireless relay device 300 and the terminal device 100. For example, the frequency bandwidth is increased by increasing the number of carriers, and is decreased by decreasing the number of carriers. The carrier is a wireless resource having a predetermined frequency bandwidth, and is, for example, a resource block in the LTE. The wireless relay device 300 determines the number of carriers to be changed based on communication information items related to the communication between the base station device 200 and the wireless relay device 300 and between the wireless relay device 300 and the terminal device 100.

Hereinafter, the determination of the number of carriers of the wireless relay device 300 according to the first embodiment will be described. In the first embodiment, the wireless relay device 300 performs wireless communication with the terminal device 100 and the base station device 200 in one or a plurality of carriers, and relays wireless communication between the terminal device 100 and the base station device 200. The wireless relay device 300 includes an acquisition unit that acquires the communication information items related to the communication between the base station device 200 and the wireless relay device 300 and between the wireless relay device 300 and the terminal device 100, and a determination unit that determines the number of carriers between the wireless relay device 300 and the terminal device 100 based on the communication information items.

The wireless relay device 300 may determine the number of carriers between the wireless relay device 300 and the terminal device 100 based on the communication information between the base station device 200 and the wireless relay device 300.

<Configuration Example of wireless Relay Device>

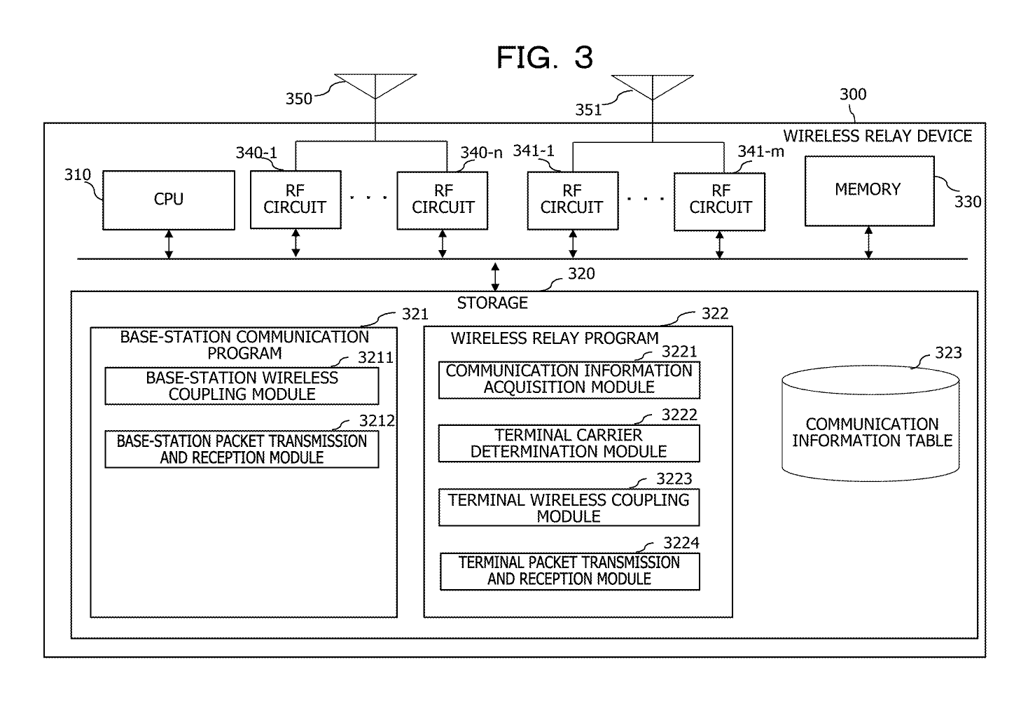

FIG. 3 is a diagram illustrating a configuration example of the wireless relay device 300. For example, the wireless relay device 300 is a smartphone or a tablet terminal having a wireless relay function. The wireless relay device 300 includes a central processing unit (CPU) 310, a storage unit 320, a memory 330 such as a dynamic random access memory (DRAM), radio frequency (RF) circuits 340-1 to 340-n, RF circuits 341-1 to 341-m, an antenna 350, and an antenna 351.

The storage unit 320 is an auxiliary storage device such a solid state drive (SSD) or a flash memory that store programs or data. The storage unit 320 stores a base-station communication program 321, a wireless relay program 322, and a communication information table 323.

The communication information table 323 is a table that stores communication information. For example, information elements stored in the communication information table 323 are a communication traffic volume (first communication traffic volume) between the base station device 200 and the wireless relay device 300, and a communication traffic volume (second communication traffic volume) between the wireless relay device 300 and the terminal device 100. For example, the communication traffic volume is a communication speed or a buffer for data transmission in the wireless relay device 300. The communication information table 323 is updated whenever the wireless relay device 300 acquires the communication information.

The memory 330 is a region into the program stored in the storage unit 320 is loaded. The memory 330 is used as a region in which the program stores data.

The RF circuits 340-1 to 340-n and the RF circuits 341-1 to 341-m are devices that realize the transmission and reception of radio waves. For example, the RF circuits 340-1 to 340-n transmit and receive the radio waves with the terminal device 100 through the antenna 350. For example, the RF circuits 341-1 to 341-m transmit and receive the radio waves with the base station device 200 through the antenna 351.

For example, one RF circuit of the RF circuits 340 of the wireless relay device 300 may transmit and receive one carrier. The wireless relay device 300 applies currents to as many RF circuits as the number of carriers used in the communication with the terminal device 100. In the wireless relay device 300, as the number of carriers used in the communication becomes larger, the currents are applied to many RF circuits. Thus, as the number of carriers becomes larger, power consumption becomes larger.

The CPU 310 is a processor which loads the program stored in the storage unit 320 into the memory 330, executes the loaded program, and realizes the respective processes.

The CPU 310 performs a base-station communication process by executing the base-station communication program 321. The base-station communication process is a process of causing the wireless relay device 300 to perform the wireless communication with the base station device 200. The base-station communication process is a process of searching for the base station device 200 capable of being wirelessly coupled, performing the wireless coupling with the detected base station device 200, and performing the transmission and reception of packets. The CPU 310 performs a process of searching for the base station device 200 capable of being wirelessly coupled and performing the wireless coupling with the detected base station device 200 by executing a base-station wireless coupling module 3211. The CPU 310 performs a transmission and reception process of the packets with the wirelessly coupled base station device 200 by executing a base-station packet transmission and reception module 3212.

The CPU 310 performs a wireless relay process by executing the wireless relay program 322. The wireless relay process is a process of causing the wireless relay device 300 to perform the wireless coupling with the terminal device 100 and to relay the packets to be transmitted and received between the base station device 200 and the terminal device 100. If an event when the number of carriers to be used in the communication with the terminal device 100 is changed is detected, the wireless relay process is a process of acquiring the communication information, determining the number of carriers to be changed, and controlling the terminal device 100 such that the terminal device performs the communication by using the determined number of carriers.

The CPU 310 constructs an acquisition unit and performs a communication information acquisition process as the acquisition unit by executing a communication information acquisition module 3221. The communication information acquisition process is a process of acquiring the communication information. The communication information is information including the communication traffic volume between the base station device 200 and the wireless relay device 300 and the communication traffic volume between the wireless relay device 300 and the terminal device 100. For example, the communication traffic volume is a communication speed in the wireless communication.

The CPU 310 constructs a determination unit and performs a terminal carrier determination process as the determination unit by executing a terminal carrier determination module 3222. The terminal carrier determination process is a process of determining the number of carriers to be used or a frequency band of a carrier to be used in the communication between the wireless relay device 300 and the terminal device 100. For example, in the terminal carrier determination process, the CPU 310 determines the number of carriers and the frequency band of the carrier to be used when the wireless coupling with the terminal device 100 is performed, and determines the number of carriers to be changed in a carrier number change event.

The CPU 310 constructs a control unit and performs a terminal wireless coupling process as the control unit by executing a terminal wireless coupling module 3223. The terminal wireless coupling process is a function of wireless coupling with the terminal device 100 using the number of carriers and the frequency band determined by the wireless relay device. For example, in the terminal wireless coupling process, the CPU 310 transmits a message for instructing that the terminal device performs the wireless coupling by using the determined frequency band and number of carriers, to the terminal device 100.

The CPU 310 performs a terminal packet transmission and reception process by executing a terminal packet transmission and reception module 3224. The terminal packet transmission and reception process is a process of transmitting and receiving the packets between the terminal device 100 and the wireless relay device 300. The wireless relay device 300 relays the packets to be transmitted and received between the base station device 200 and the terminal device 100 by performing the terminal packet transmission and reception process in cooperation with the above-described base-station packet transmission and reception process.

<Configuration Example of Terminal Device>

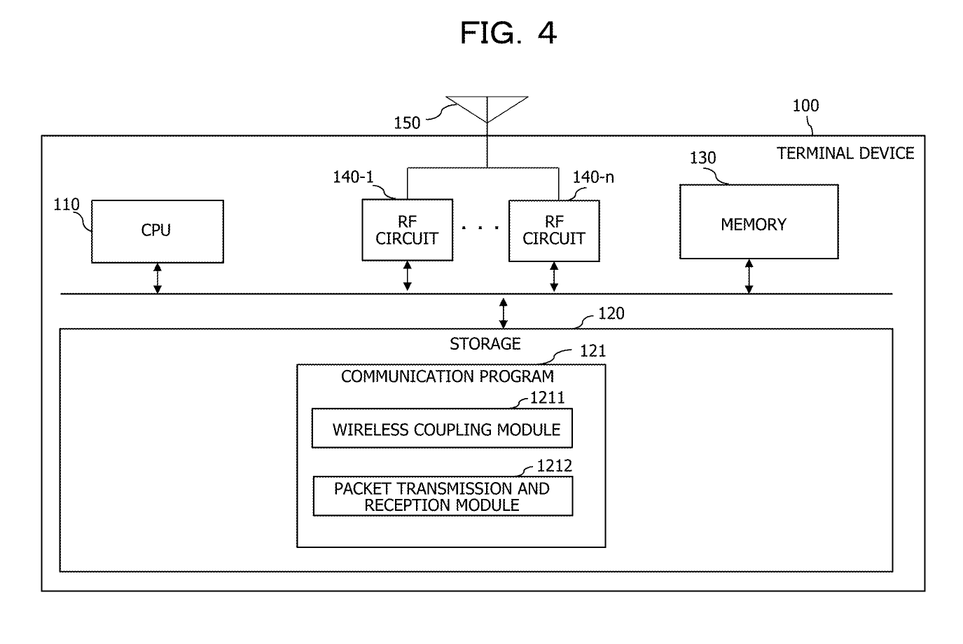

FIG. 4 is a diagram illustrating a configuration example of the terminal device 100. For example, the terminal device 100 is a smartphone or a tablet terminal, and includes a CPU 110, a storage 120, a memory 130 such as a DRAM, RF circuits 140-1 to 140-n, and an antenna 150.

The CPU 110, the storage 120, the memory 130, the RF circuits 140-1 to 140-n, and the antenna 150 are the same devices as the CPU 310, the storage unit 320, the memory 330, the RF circuits 340-1 to 340-n, and the antenna 350 of FIG. 3.

Here, the storage 120 stores a communication program 121.

The CPU 110 constructs a reception unit and a wireless control unit and performs a communication process as the reception unit and the wireless control unit by executing the communication program 121. The communication process is a process of communicating with the wireless relay device 300 or the base station device 200. For example, the communication program 121 is the same as the base-station communication program 321 included in the wireless relay device 300. Similarly, a wireless communication module 1211 is the same as the base-station wireless coupling module 3211, and a packet transmission and reception module 1212 is the same as the base-station packet transmission and reception module 3212. That is, the wireless communication between the terminal device 100 and the wireless relay device 300 is the same as the wireless communication between the wireless relay device 300 and the base station device 200.

<Configuration Example of Base Station Device>

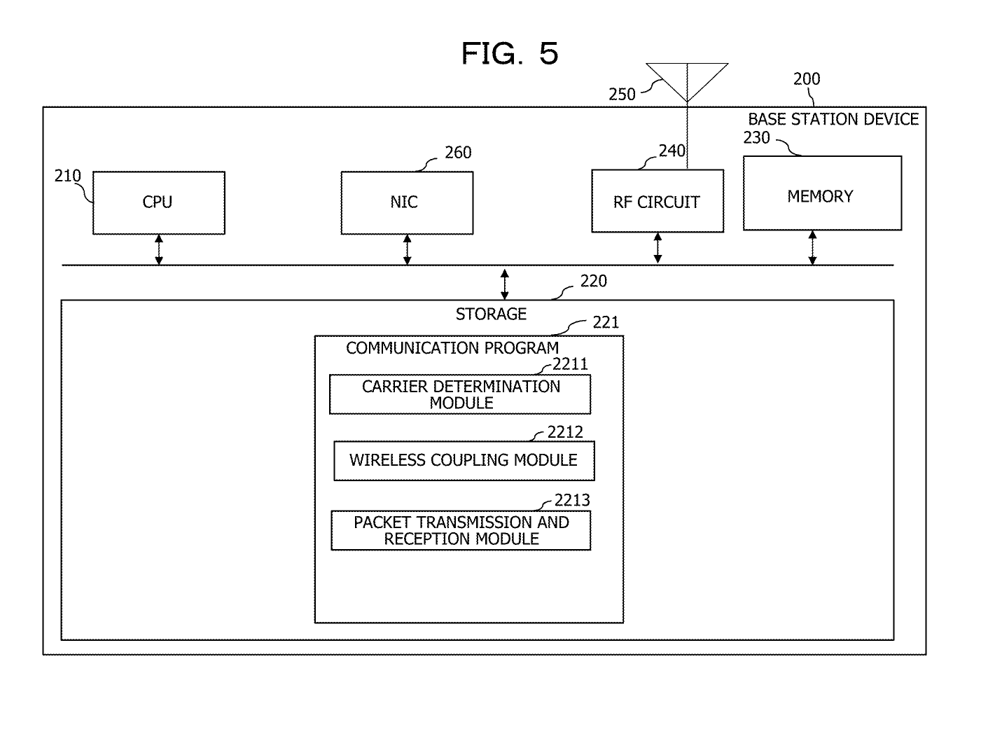

FIG. 5 is a diagram illustrating a configuration example of the base station device 200. The base station device 200 includes a CPU 210, a storage 220, a memory 230, an RF circuit 240, an antenna 250, and a network interface card (NIC) 260.

The CPU 210, the storage 220, the memory 230, the RF circuit 240, and the antenna 250 are the same devices as the CPU 310, the storage unit 320, the memory 330, the RF circuits 340-1 to 340-n, and the antenna 350 of FIG. 3.

Here, the storage 220 stores a communication program 221.

The NIC 260 is a device that is coupled with the external network 400 and performs communication. For example, the NIC 260 is coupled with a gateway that relays communication between different networks, a base station control device that controls a plurality of base station devices, a switch, and a hub in a wired manner using an optical cable.

The CPU 210 performs the communication process by executing the communication program 221. The communication process is a process of communicating with the wireless relay device 300 or the terminal device 100.

The CPU 210 performs a carrier determination process by executing a carrier determination module 2211. The carrier determination process is a process of determining the number of carriers and the frequency band of the carrier to be used in the wireless communication with the plurality of terminal devices or the wireless relay device within the communication area A200. For example, the base station device 200 searches for carriers having a degree of interference among carriers other than the carriers allocated to the device other than the wireless relay device 300, and determines the carriers based on wireless communication ability of the wireless relay device 300.

The CPU 210 performs a wireless coupling process by executing a wireless coupling module 2212. The wireless coupling process is a process of wirelessly coupling with the terminal device or the wireless relay device 300 within the communication area A200, and is the same as the terminal wireless coupling process of the wireless relay device 300.

The CPU 210 performs a packet transmission and reception process by executing a packet transmission and reception module 2213. The packet transmission and reception process is a process of transmitting and receiving the packets with the terminal device or the wireless relay device 300 within the communication area A200, and is the same as the terminal packet transmission and reception process of the wireless relay device 300.

<Carrier Number Change Process>

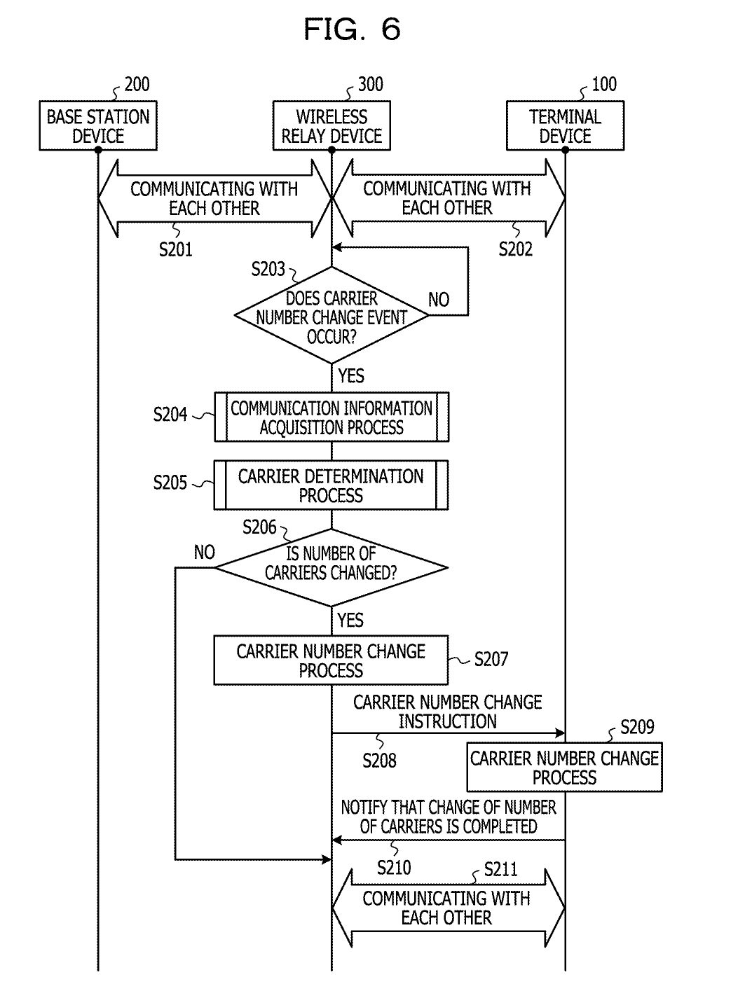

FIG. 6 is a diagram illustrating an example of a sequence of a carrier number change process of the communication system 10. The base station device 200 and the wireless relay device 300 are communicating with each other, and the wireless relay device 300 and the terminal device 100 are communicating with each other (S201, S202).

The wireless relay device 300 monitors the carrier number change event until the carrier number change event occurs (No in S203). For example, the carrier number change event regularly occurs every one minute. For example, the wireless relay device 300 issues an interval timer, and detects timeout of the interval timer, as the carrier number change event.

If the carrier number change event occurs (Yes in S203), the wireless relay device 300 performs the communication information acquisition process (S204).

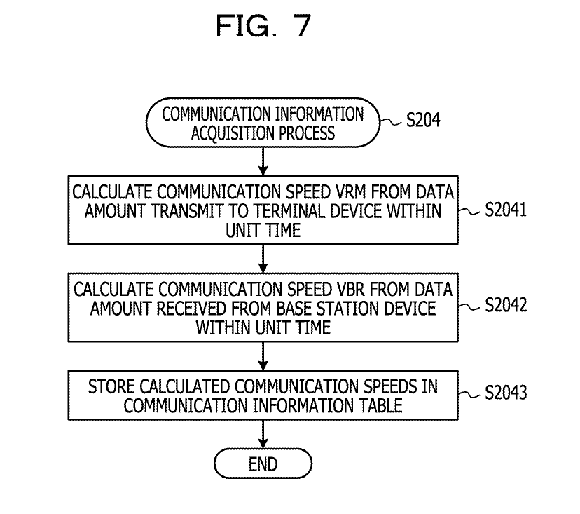

FIG. 7 is a diagram illustrating an example of a process flowchart of the communication information acquisition process S204. The wireless relay device 300 calculates a communication speed with the terminal device 100 from a data amount transmitted to the terminal device 100 within a unit time (S2041). A communication speed (second communication speed) with the terminal device 100 to be calculated is, for example, a communication speed of a downlink (direction from the base station device 200 to the terminal device 100), and is referred to as a communication speed VRM (Velocity Relay station to Mobile station). For example, the data amount transmitted to the terminal device 100 within the unit time is stored in an internal memory by the wireless relay device 300.

The wireless relay device 300 calculates the communication speed with the base station device 200 from the data amount received from the base station device 200 within a unit time (S2042). A communication speed (first communication speed) with the base station device 200 to be calculated is, for example, a communication speed of a downlink, and is referred to as a communication speed VBR (Velocity Base station to Relay station). Similarly to the data amount transmitted to the terminal device 100, the data amount received from the base station device 200 within the unit time is stored in the internal memory by the wireless relay device 300.

The wireless relay device 300 stores the calculated communication speed VRM and communication speed VBR in the communication information table 323 (S2043).

The communication information items acquired in the communication information acquisition process 5204 of FIG. 7 are the downlink communication speeds between the base station device 200 and the wireless relay device 300 and between the wireless relay device 300 and the terminal device 100. The communication information items acquired in the communication information acquisition process are used as indices in the subsequent carrier determination process. The indices in the carrier determination process may be communication speeds of an uplink (direction from the terminal device 100 to the base station device 200). In a case where the indices in the carrier determination process are used as the uplink communication speeds, the communication information items (first and second communication speeds) acquired in the communication information acquisition process are acquired as the uplink communication speeds.

Referring back to FIG. 6, the wireless relay device 300 performs the carrier determination process (S205).

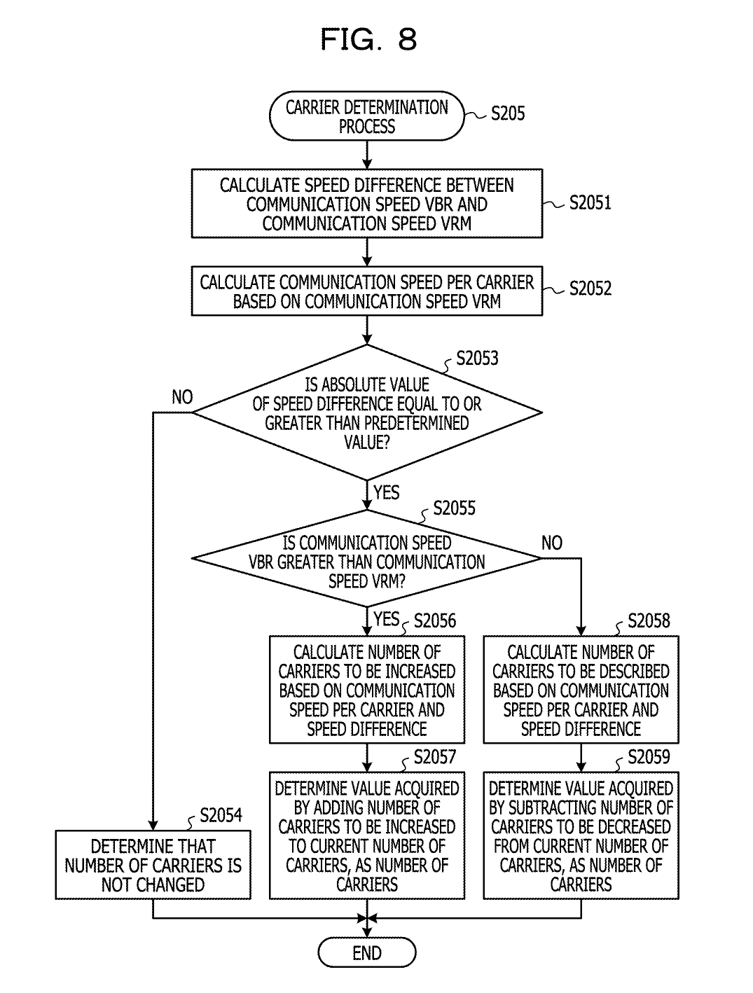

FIG. 8 is a diagram illustrating an example of a process flowchart of the carrier determination process S205. The wireless relay device 300 calculates a speed difference between the communication speed VBR and the communication speed VRM from the acquired communication information items (S2051). For example, the speed difference is calculated by subtracting the communication speed VRM from the communication speed VBR.

The wireless relay device 300 calculates a communication speed per carrier based on the communication speed VRM (S2052). The wireless relay device 300 regards a value acquired by dividing the measured communication speed VRM by the number of carriers being used in the communication between the wireless relay device 300 and the terminal device 100, as a communication speed per carrier.

The wireless relay device 300 determines whether an absolute value of the speed difference is equal or greater than a predetermined value (S2053). In a case where the absolute value of the speed difference is less than the predetermined value (No in S2053), the wireless relay device 300 determines that the difference between the communication speed VBR and the communication speed VRM is small enough not to increase or decrease the number of carriers, and determines not to change the number of carriers (S2054). For example, the predetermined value is a communication speed per carrier which is calculated in the calculation process S2052. For example, the predetermined value may be a theoritical value of the communication speed per carrier which is previously stored in the memory.

In a case where the absolute value of the speed difference is equal or greater than the predetermined value (Yes in S2053), the wireless relay device 300 performs a process of increasing or decreasing the number of carriers in the communication with the terminal device 100.

Subsequently, the wireless relay device 300 determines whether or not the communication speed VBR is greater than the communication speed VRM (S2055). Hereinafter, a case where the communication speed VBR is greater than the communication speed VRM (communication speed VBR>communication speed VRM) and a case where the communication speed VBR is equal to or less than the communication speed VRM (communication speed VBR≦communication speed VRM) will be described.

<1. Case Where Communication Speed VBR is Greater Than Communication Speed VRM (Communication Speed VBR>Communication Speed VRM)>

In a case where the communication speed VBR is greater than the communication speed VRM (Yes in S2055), the wireless relay device 300 calculates the number of carriers to be increased based on the communication speed per carrier and the communication speed difference (S2056). The wireless relay device 300 sets the communication speed VBR and the communication speed VRM to be equal to each other by increasing the number of carriers in the communication with the terminal device 100. That is, a quotient acquired by dividing the communication speed difference acquired by subtracting the communication speed VRM from the communication speed VBR by the communication speed per carrier is used as the number of carriers to be increased. However, in most cases, since the communication speed difference is not integer multiple of the communication speed per carrier, the quotient acquired through the dividing is a value including a decimal mark. Thus, the wireless relay device 300 determines the number of carriers to be increased by adding a condition (hereinafter, referred to as a first condition) in which the communication speed VBR is less than the communication speed VRM or a condition (hereinafter, referred to as a second condition) in which the communication speed VBR is greater than the communication speed VRM as a handling condition of the fractional part subsequent to the decimal mart.

<1.1 Case Where First Condition is Satisfied>

For example, if the first condition (communication speed VBR<communication speed VRM) is set, since the communication speed VRM is increased, the discarding of downlink data due to the occurrence of a buffer overflow caused by the retention of the downlink data from the wireless relay device 300 to the terminal device 100 is avoided.

In this case, the wireless relay device 300 determines the minimum number of carriers to be increased, which satisfies the first condition, as the number of carriers to be increased (S2056). That is, the wireless relay device 300 uses a value acquired by rounding the fractional part of the quotient acquired by dividing the communication speed difference by the communication speed per carrier, as the number of carriers to be increased.

<1.2 Case Where Second Condition is Satisfied>

For example, if the second condition (communication speed VBR>communication speed VRM) is set, since the wireless resources are insufficient, the avoidance of the wasteful use of the wireless resources is put above the prevention of the occurrence of the data discarding.

In this case, the wireless relay device 300 determines the maximum number of carriers to be increased which satisfies the second condition, as the number of carriers to be increased (S2056). That is, the wireless relay device 300 uses a value acquired by truncating the fractional part of the quotient acquired by dividing the communication speed difference by the communication speed per carrier, as the number of carriers to be increased. In a case where the second condition is satisfied, since the fractional part is truncated, the number of carriers to be increased is less than that in the first condition by one, and thus, it is possible to reduce the number of wireless resources to be used.

<2. Case Where Communication Speed VBR is Equal or Less Than Communication Speed VRM (Communication Speed VBR Communication Speed VRM)>

In a case where the communication speed VBR is less than the communication speed VRM (No in S2055), the wireless relay device 300 calculates the number of carriers to be decreased based on the communication speed per carrier and the communication speed difference (S2058). The wireless relay device 300 sets the communication speed VBR and the communication speed VRM to be equal to each other by decreasing the number of carriers in the communication with the terminal device 100.

In a case where the communication speed difference is not integer multiple of the communication speed per carrier, the number of carriers to be decreased is determined such that the first condition and the second condition to be described below are satisfied, similarly to the case where the communication speed VBR is less than the communication speed VRM.

<2.1 Case Where First Condition is Satisfied>

In this case, the wireless relay device 300 determines the maximum number of carriers to be decreased which satisfies the first condition, as the number of carriers to be decreased (S2058). That is, the wireless relay device 300 uses a value acquired by truncating the fractional part of the quotient acquired by dividing the communication speed difference by the communication speed per carrier, as the number of carriers to be decreased.

<2.2 Case Where Second Condition is Satisfied>

In this case, the wireless relay device 300 determines the minimum number of carriers to be decreased which satisfies the second condition, as the number of carriers to be decreased (S2058). That is, the wireless relay device 300 uses a value acquired by truncating the fractional part of the quotient acquired by dividing the communication speed difference by the communication speed per carrier, as the number of carriers to be decreased. In a case where the second condition is satisfied, since the fractional part is rounded, the number of carriers to be increased is greater than that in the first condition by one, and thus, it is possible to reduce the number of wireless resources to be used.

As stated above, the wireless relay device 300 determines the number of carriers to be increased or the number of carriers to be decreased (S2056, S2058), and determines a value (S2057) acquired by adding the number of carriers to be increased to the current number of carriers or a value (S2059) acquired by subtracting the number of carriers to be decreased from the current number of carriers, as the number of carriers.

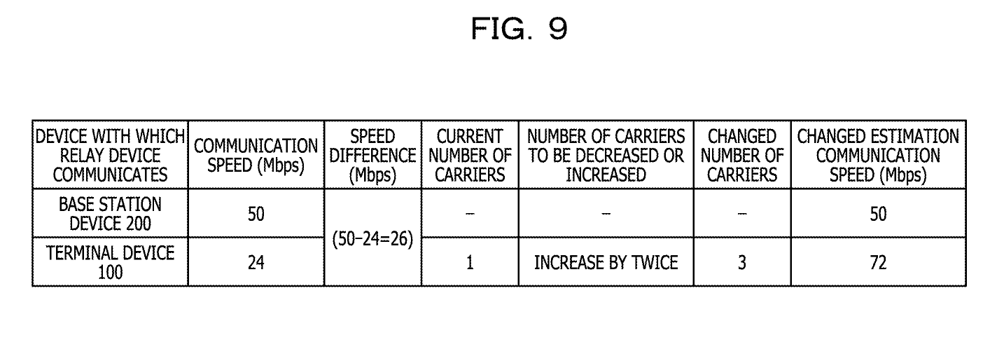

FIG. 9 is a diagram illustrating an example in a case where the number of carriers is increased. In the example of FIG. 9, the communication speed (communication speed VBR) with the base station device 200 is 50 Mbps (Mega bit per second), and the communication speed (communication speed VRM) with the terminal device 100 is 24 Mbps. Hereinafter, the example of FIG. 9 will be described with reference to the process flowchart of FIG. 8.

The wireless relay device 300 calculates 26 Mbps which is the speed difference by subtracting the communication speed VRM from the communication speed VBR (S2051). The wireless relay device 300 calculates the communication speed per carrier based on the communication speed VRM (S2052). Referring to FIG. 9, since the current number of carriers is 1 and the communication speed VRM is 24 Mbps, the wireless relay device 300 calculates 24 Mbps which is the communication speed per carrier. The wireless relay device 300 determines that the absolute value of the speed difference which is 26 Mbps is equal or greater than a predetermined value (here, 24 Mbps which is the communication speed per carrier) (Yes in S2053).

Since the communication speed VBR (50 Mbps) is greater than the communication speed VRM (24 Mbps) (Yes in S2055), the wireless relay device 300 calculates the number of carriers to be increased based on the speed difference and the communication speed per carrier which is 24 Mbps (S2056).

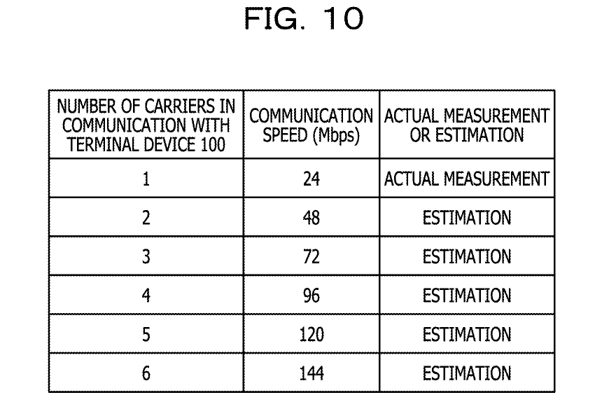

FIG. 10 is a diagram illustrating an example of a measurement value and an estimation value of the communication speed for each carrier number. In FIG. 10, if, the wireless relay device 300 estimates that the communication speed per carrier will be increased from 24 Mbps which is the calculated communication speed per carrier by 48 Mbps if the number of carriers is increased by two carriers and will be increased by 72 Mbps if the number of carriers is increased by three carriers.

The wireless relay device 300 uses the minimum number of carriers as the number of carriers to be increased in a range in which the communication speed VRM is greater than the communication speed VBR by increasing the number of carriers. That is, the wireless relay device 300 uses the minimum number of carriers which exceeds the speed difference, as the number of carriers to be increased. As illustrated in FIG. 10, the wireless relay device 300 determines that the number of carriers is increased by two carriers (increased by 48 Mbps).

The wireless relay device 300 determines 3 which is the number of carriers acquired by adding 2 which is the number of carriers to be increased to 1 which is the current number of carriers, as the new number of carriers between the wireless relay device 300 and the terminal device 100 (S2057).

As mentioned above, in a case where the communication speed between the wireless relay device 300 and the terminal device 100 is less than the communication speed between the base station device 200 and the wireless relay device 300, the wireless relay device 300 increases the number of carriers in the communication with the terminal device 100. Accordingly, it is possible to perform the transmission and reception of a large amount of data between the wireless relay device 300 and the terminal device 100 at a high speed so as to correspond to the communication speed between the base station device 200 and the wireless relay device 300.

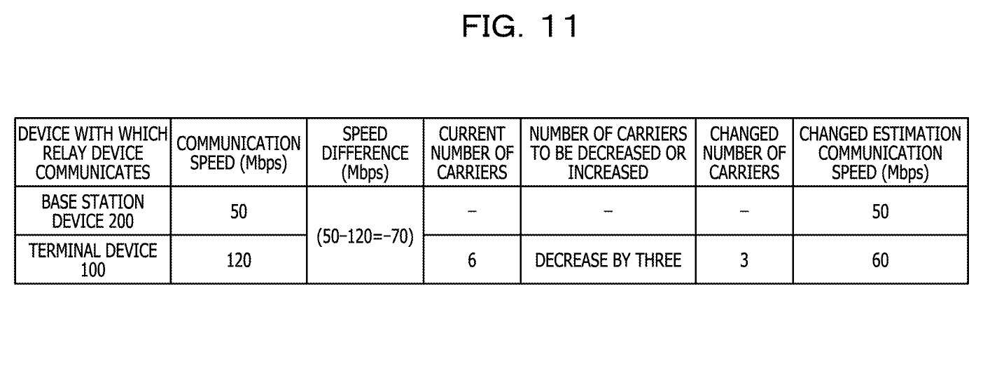

Hereinafter, an example in which the number of carriers is decreased will be described. FIG. 11 is a diagram illustrating an example in which the number of carriers is decreased. In FIG. 11, the communication speed (communication speed VBR) with the base station device 200 is 50 Mbps, and the communication speed (communication speed VRM) with the terminal device 100 is 120 Mbps. Hereinafter, the example of FIG. 11 will be described with reference to the process flowchart of FIG. 8.

The wireless relay device 300 calculates −70 Mbps which is the speed difference by subtracting the communication speed VRM from the communication speed VBR (S2051). Since the current number of carriers is 6 and the communication speed VRM is 120 Mbps, the wireless relay device 300 calculates 20 Mbps which is the communication speed per carrier (S2052). The wireless relay device 300 determines that 70 Mbps which is the absolute value of the speed difference is equal or greater than a predetermined value (here, 20 Mbps which is the communication speed per carrier) (Yes in S2053).

Since the communication speed VBR (50 Mbps) is less than the communication speed VRM (120 Mbps) (No in S2055), the wireless relay device 300 calculates the number of carriers to be decreased based on the communication speed per carrier and the speed difference (S2058).

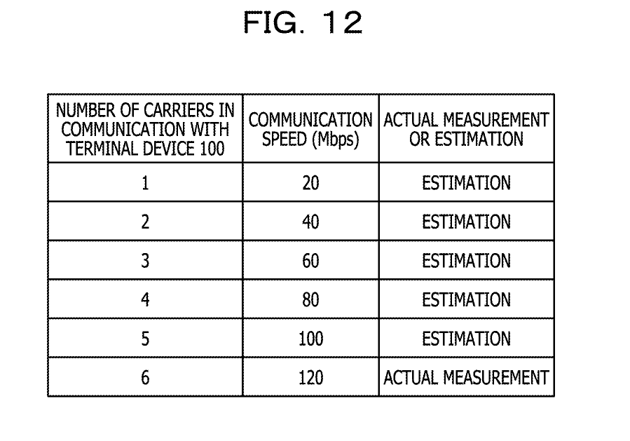

FIG. 12 is a diagram illustrating an example of a measurement value and an estimation value of the communication speed for each carrier number. In FIG. 12, the wireless relay device 300 estimates that the communication speed per carrier will be decreased from 20 Mbps which is the calculated communication speed per carrier by 40 Mbps if the number of carriers is decreased by two carriers and will be decreased by 60 Mbps if the number of carriers is decreased by three carriers.

The wireless relay device 300 uses the maximum number of carriers capable of being decreased in a range in which the communication speed VRM is not less than the communication speed VBR, as the number of carriers to be decreased. That is, the wireless relay device 300 uses the maximum number of carriers which does not exceed the absolute value of the speed difference, as the number of carriers to be decreased. As illustrated in FIG. 12, the wireless relay device 300 determines the number of carriers to be decreased, as three carriers (decreased by 60 Mbps).

The wireless relay device 300 determines 3 which is the number of carriers acquired by subtracting 3 which is the number of carriers to be decreased from 6 which is the current number of carriers, as the new number of carriers between the wireless relay device 300 and the terminal device 100 (S2059).

As stated above, in a case where the communication speed between the wireless relay device 300 and the terminal device 100 is greater than the communication speed between the base station device 200 and the wireless relay device 300, the wireless relay device 300 decreases the number of carriers. Accordingly, it is possible to release the supernumerary wireless resources which are allocated in the transmission and reception of the data in the wireless resources between the wireless relay device 300 and the terminal device 100. It is possible to reduce the power consumption caused by the transmission and reception of carriers by stopping the transmission and reception of the carriers in which the data is not transmitted and received.

Referring back to FIG. 6, the wireless relay device 300 checks whether or not the number of carriers is changed (S207). The wireless relay device 300 compares the current number of carriers with the determined number of carriers, and ends the process in a case where the number of carriers is not changed (No in S206), and monitors the occurrence of the carrier number change event again (S203).

In a case where the number of carriers is changed (Yes in S206), the wireless relay device 300 performs the carrier number change process of the wireless relay device 300 (S207). The carrier number change process is a process of turning on or off the RF circuit depending on the determined number of carriers.

The wireless relay device 300 transmits a carrier number change instruction to the terminal device 100 (S208). The carrier number change instruction is a message including information such as the number of carriers and the frequency band of the carrier to be used, and is, for example, a PSBCH in D2D. The terminal device 100 that receives the carrier number change instruction performs the carrier number change process (S209). Similarly to the carrier number change process of the wireless relay device 300, the carrier number change process is a process of turning the RF circuit. The terminal device 100 transmits a carrier number change notification indicating that the change of the number of carriers is completed to the wireless relay device 300 (S210), and returns to the communication with the wireless relay device 300 (S211).

In the first embodiment, the wireless relay device 300 changes the number of carriers in the communication of the terminal device 100 based on the communication speed between the terminal device 100 and the base station device 200, and approaches the communication speed with the terminal device 100 to the communication speed with the base station device 200. In so doing, in the communication with the base station device 200, the wireless relay device 300 efficiently uses the wireless resources by performing the transmission and reception of the data without delay while avoiding the wasteful use of the wireless resources.

The base station device 200 determines the wireless resources to be used in the communication with the wireless relay device 300 in consideration of the communication with another terminal device or wireless relay device within the communication area A200. Accordingly, if the wireless relay device 300 changes the wireless resources in the communication with the base station device 200, there are some cases where the wireless communication with another terminal device or wireless relay device has an influence such as the occurrence of interference or the insufficiency of the wireless resources. Thus, in the first embodiment, it is possible to efficiently use the wireless resources while suppressing the influence on the wireless communication with another device by changing only the wireless resources in the communication with the terminal device 100, which are the wireless resources determined by the wireless relay device 300.

### Second Embodiment

Hereinafter, a second embodiment will be described. The carrier determination process according to the first embodiment is to increase or decrease the number of carriers based on any one of the downlink (and uplink) communication speeds. In the second embodiment, an index determination process of determining whether to increase or decrease the number of carriers based on any one communication speed of the downlink and uplink communication speeds is provided. As the index, the wireless relay device 300 uses any one combination of a downlink combination of a downlink communication speed at which the data is transmitted in the downlink from the base station device 200 to the terminal device 100 and an uplink combination of an uplink communication speed at which the data is transmitted in the uplink from the terminal device 100 to the base station device 200, as an index.

<Carrier Determination Process>

A sequence of a carrier determination process according to the second embodiment is the same as the sequence illustrated in FIG. 6. Hereinafter, the communication information acquisition process S204 and the carrier determination process S205 will be described.

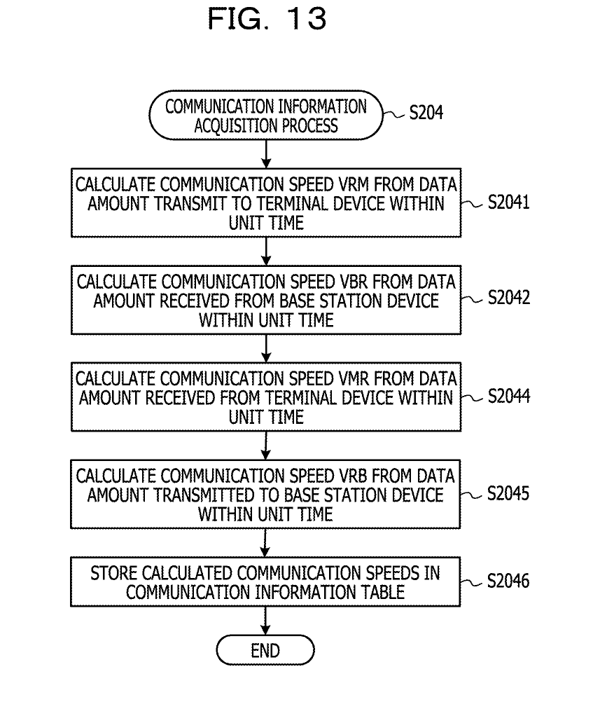

FIG. 13 is a diagram illustrating an example of a process flowchart of the communication information acquisition process S204 according to the second embodiment. In addition to the communication information acquisition process according to the first embodiment, the communication speed VRM is calculated from the data amount received from the terminal device within the unit time (S2044), and the communication speed VBR is calculated from the data amount transmitted to the base station device within the unit time (S2045). That is, the wireless relay device 300 acquires the communication speed in both the uplink and downlink directions. The wireless relay device 300 stores the calculated communication speeds in both the uplink and downlink directions in the communication information table 323 (S2046).

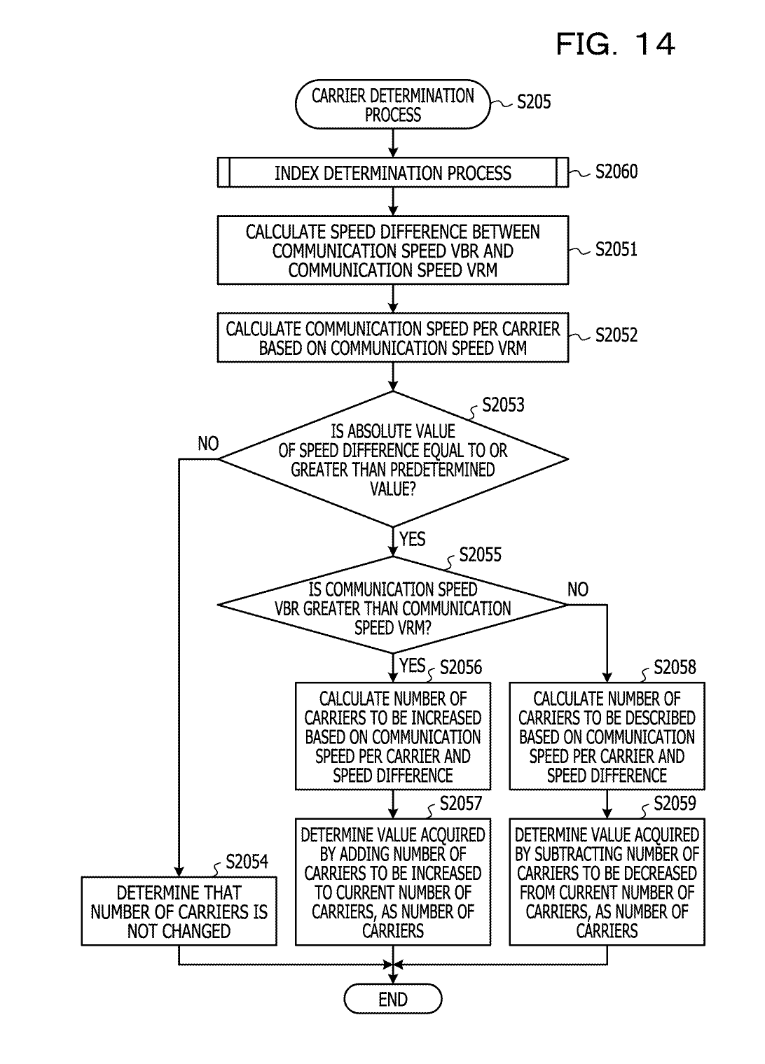

FIG. 14 is a diagram illustrating an example of a process flowchart of the carrier determination process 205 according to the second embodiment. The carrier determination process according to the second embodiment includes an index determination process (S2060) as a first step of the carrier number change process according to the first embodiment. The wireless relay device 300 performs the determination of whether to increase or decrease the number of carriers based on any one communication speed of the downlink and uplink communication speeds in the first step of the carrier determination process. The wireless relay device 300 determines whether to increase or decrease the number of carriers by performing the carrier determination process by using the determined downlink or uplink communication speed as the index.

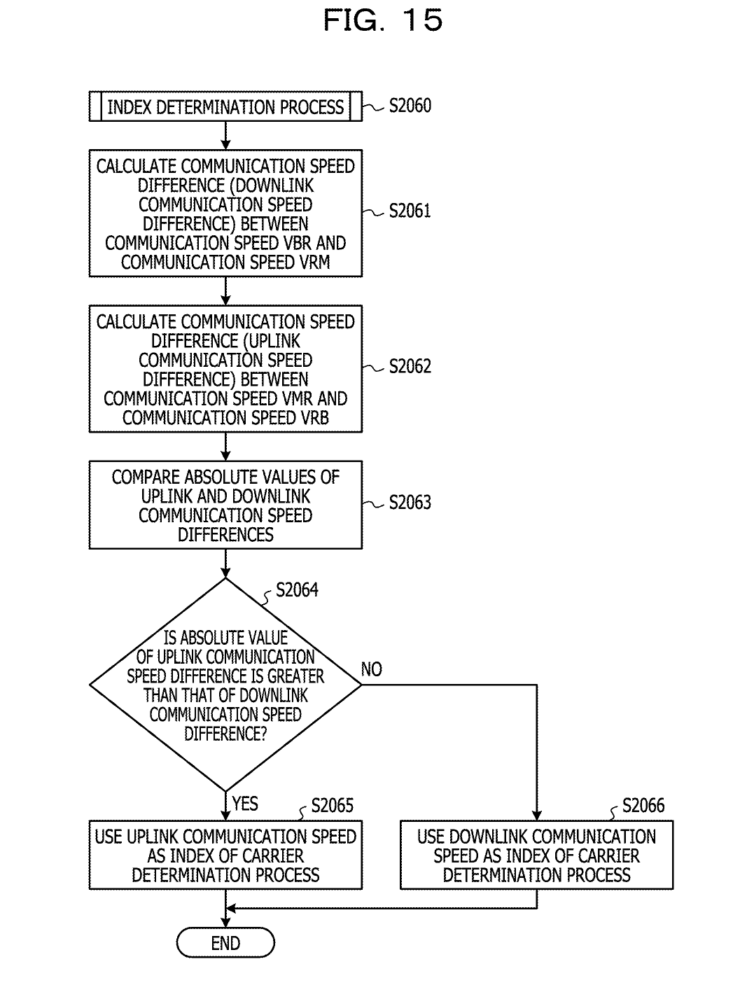

FIG. 15 is a diagram illustrating an example of a process flowchart of the index determination process. In the index determination process, the wireless relay device 300 calculates a communication speed difference (hereinafter, referred to as a downlink communication speed difference) between the communication speed VBR and the communication speed VRM (S2061). The wireless relay device 300 calculates a communication speed difference (hereinafter, referred to as an uplink communication speed difference) between the uplink communication speed from the wireless relay device 300 to the base station device 200 and the uplink communication speed from the terminal device 100 to the wireless relay device 300 (S2062). Hereinafter, the uplink communication speed from the wireless relay device 300 to the base station device 200 is referred to as a communication speed VRB (Velocity Relay station to Base station), and the uplink communication speed from the terminal device 100 to the wireless relay device 300 is referred to as a communication speed VMR (Velocity Mobile station to Relay station).

The wireless relay device 300 compares the absolute values between the uplink and downlink communication speed differences (S2063). In a case where the uplink communication speed difference is greater than the downlink communication speed difference (Yes in S2064), the wireless relay device 300 determines the uplink communication speed (combination of the communication speed VRB and the communication speed VMR) as the index of the carrier determination process (S2065). In a case where the uplink communication speed difference is not greater than the downlink communication speed difference (No in S2064), the wireless relay device 300 determines the downlink communication speed (combination of the communication speed VBR and the communication speed VRM) as the index of the carrier determination process (S2066).

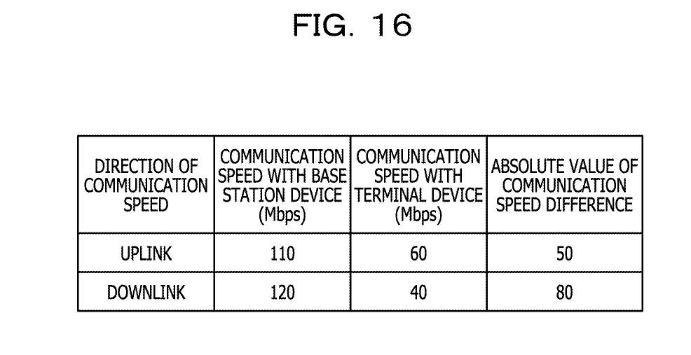

FIG. 16 is a diagram illustrating an example of the uplink and downlink communication speeds. Referring to FIG. 16, the uplink communication speed is 110 Mbps in the communication with the base station device 200, is 60 Mbps in the communication with the terminal device 100, and the absolute value of the uplink communication speed difference is 50 Mbps. Referring to FIG. 16, the downlink communication speed is 120 Mbps in the communication with the base station device 200, is 40 Mbps in the communication with the terminal device 100, and the absolute value of the downlink communication speed difference is 80 Mbps. Hereinafter, the case of FIG. 16 will be described with reference to the process flowchart of FIG. 15.

The wireless relay device 300 compares the uplink and downlink communication speed differences (S2064), determines that the downlink communication speed difference is greater than the uplink communication speed difference (No in S2064), and determines the downlink communication speed as the index of the carrier determination process (S2066).

As the communication speed difference becomes larger, the wireless relay device 300 is not able to more efficiently use the wireless resources. For example, as the communication speed with the terminal device 100 becomes greater than the communication speed with the base station device 200, the number of wireless resources in which the data is not transmitted becomes larger. For example, as the communication speed with the terminal device 100 becomes less than the communication speed with the base station device 200, the amount of data which is not capable of being transmitted and received to and from the base station device 200 becomes larger. Thus, the communication speed in a direction in which the communication speed difference is larger is to be preferentially improved.

In the second embodiment, the wireless relay device 300 uses the communication speed of the uplink and downlink communication speeds in which the communication speed difference between the terminal device 100 and the base station device 200 is larger, as the index for determining whether to increase or decrease the number of carriers. Accordingly, the wireless relay device 300 can preferentially improve the communication speed of the uplink and downlink communication speeds in a direction in which the wireless resources are to be further improved.

### Third Embodiment

Hereinafter, a third embodiment will be described. In the third embodiment, the wireless relay device includes a downlink buffer that accumulates data to be relayed to the terminal device and an uplink buffer that accumulates data to be relayed to the base station device. The communication information includes an uplink data retention amount indicating a data amount that is retained in the uplink buffer and a downlink data retention amount indicating a data amount that is retained in the downlink buffer. The wireless relay device determines the number of carriers based on the uplink and downlink data retention amounts.

<Control of Uplink Buffer and Downlink Buffer>

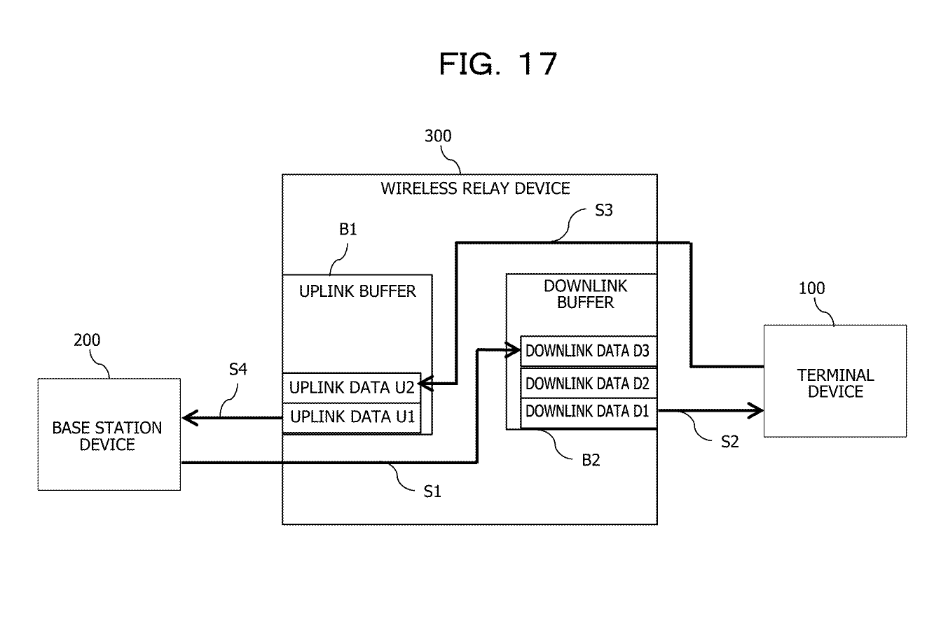

FIG. 17 is a diagram illustrating an example of the control of the uplink and downlink buffers of the wireless relay device 300. The control of the uplink buffer and the downlink buffer will be described below with reference to FIG. 17.

The wireless relay device 300 includes an uplink buffer B1 and a downlink buffer B2. The wireless relay device 300 accumulates the data received from the terminal device 100 in the uplink buffer B1, and transmits the accumulated data to the base station device 200 in the order from the oldest data to the newest data. Similarly, the wireless relay device 300 accumulates the data received from the base station device 200 in the downlink buffer B2, and transmits the accumulated data to the terminal device 100 in the order from the oldest data to the newest data. For example, the uplink buffer B1 and the downlink buffer B2 are first in, first out (FIFO) buffers, and are buffers to be sequentially transmitted in the order in which the data is accumulated. The uplink buffer B1 and the downlink B2 have predetermined buffer sizes, respectively, and the wireless relay device 300 discards the data without accumulating the data in the buffer if the data that exceeds the buffer size is received.

The control of the downlink buffer B2 of the wireless relay device 300 will be described. The base station device 200 transmits data D3 to the wireless relay device 300 (S1). The wireless relay device 300 receives the data D3 receives, and accumulates the received data in the downlink buffer B2. In this case, data D1 and data D2 transmitted from the base station device 200 are accumulated in the downlink buffer B2 before the data D3 is accumulated. The wireless relay device 300 accumulates the data D3 after the data D1 and the data D2. The wireless relay device 300 transmits the data D1 which is the oldest data accumulated in the downlink buffer B2 to the terminal device 100 in a timing when the data is transmitted to the terminal device 100 (S2).

The same is true of the control of the uplink buffer B1 of the wireless relay device 300. The wireless relay device 300 receives data U2 from the terminal device 100 (S3), and accumulates the received data in the uplink buffer B1. Data U1 which is the oldest data accumulated in the uplink buffer B1 is transmitted to the base station device 200 in a timing when the data is transmitted to the base station device 200 (S4).

As stated above, the wireless relay device 300 accumulates the data in the buffer in a timing when the data is received, and transmits the data in the order from the oldest data to the newest data in a timing when the data is transmitted. Thus, in a case where the communication speed on the reception side is greater than the communication speed on the transmission side, since the amount of received data per time is greater than the amount of transmitted data, the data is accumulated in the buffer. That is, the data being accumulated (retained) in the uplink buffer means that the communication speed VRB is less than the communication speed VMR. Similarly, a case where the data is accumulated (retained) in the downlink buffer means that the communication speed VBR is greater than the communication speed VRM.

<Carrier Number Change Process>

A sequence of a carrier determination process according to a third embodiment is the same as the sequence illustrated in FIG. 6. Hereinafter, the communication information acquisition process S204 and the carrier determination process S205 will be described.

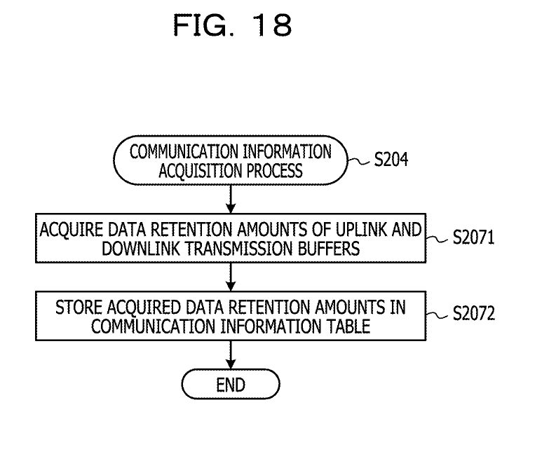

FIG. 18 is a diagram illustrating an example of a process flowchart of the communication information acquisition process S204 according to the third embodiment. The wireless relay device 300 acquires the data retention amounts indicating the data amounts stored (accumulated) in the uplink buffer and the downlink buffer (S2071). For example, the wireless relay device 300 acquires the data retention amounts by referring to the data amounts retained in the uplink and downlink buffers within the buffer. The wireless relay device 300 stores the acquired uplink data retention amount and downlink data retention amount in the communication information table 323 (S2072).

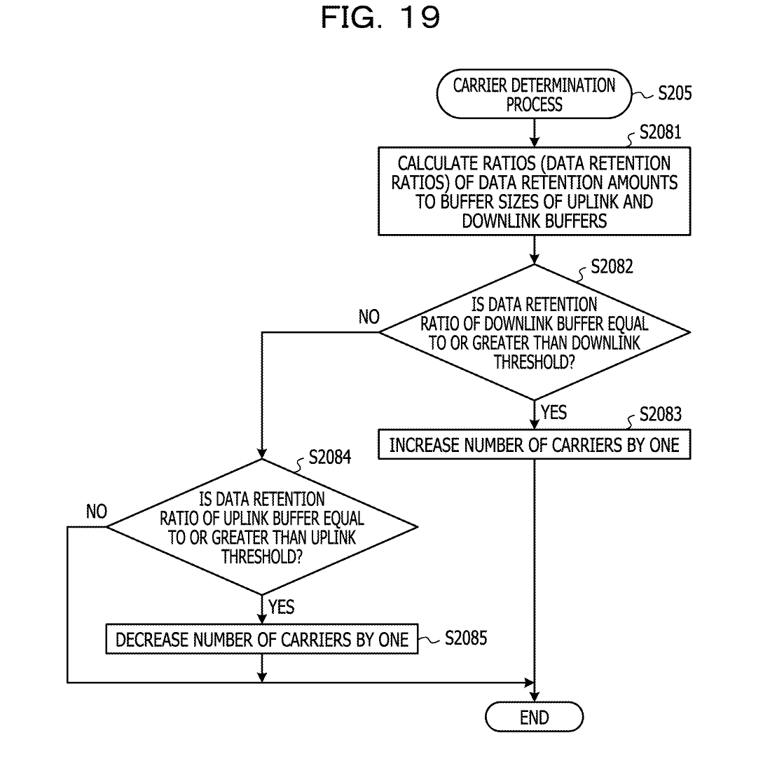

FIG. 19 is a diagram illustrating an example of a process flowchart of the carrier determination process S205 according to the third embodiment. The wireless relay device 300 calculates ratios (data retention ratios) of the data retention amounts to the buffer sizes of the uplink and downlink buffers (S2081). The wireless relay device 300 calculates the uplink data retention ratio by dividing the uplink data retention amount by the size of the uplink buffer. Similarly, the wireless relay device 300 calculates the downlink data retention ratio by dividing the downlink data retention amount by the size of the downlink buffer.

The wireless relay device 300 determines whether or not the data retention ratio of the downlink buffer is equal or greater than a downlink threshold (S2082). In a case where the data retention ratio of the downlink buffer is equal or greater than the downlink threshold (Yes in S2082), the wireless relay device 300 increases the number of carriers between the wireless relay device 300 and the terminal device 100 by one irrespective of the data retention ratio of the uplink buffer (S2083). If the number of carriers is increased, the downlink communication speed with the terminal device 100 is increased, and the data retained in the downlink buffer is transmitted and reduced.

In general, since it is assumed that the data is accumulated in the buffer due to the occurrence of an error in a wireless communication unit, a wireless communication system is designed to take a predetermined time until the data retention ratio becomes 100%. Since data redundancy occurs as stated above, it is assumed that the downlink threshold is, for example, 50% which is sufficiently smaller than 100% in the present embodiment. For example, the downlink threshold may be a value set such that the data retention ratio does not exceed 100% even though the maximum number of data packets is received within a next predetermined time based on the downlink communication speed with the base station device 200 and the downlink communication speed with the terminal device 100. The downlink threshold capable of being controlled in this manner may be notified and applied from the base station device 200 to the wireless relay device 300 during the communication of the data.

In a case where the communication speed difference between the base station device 200 and the terminal device 100 is large, if the number of carriers to be increased is 1, there are some cases where the communication speed difference does not become sufficiently small. In this case, the process of FIG. 6 is repeatedly performed, it is assumed that the data retention ratio of the downlink buffer is equal or greater than the downlink threshold even in the next carrier number change event, and the wireless relay device 300 further increases the number of carriers by one. The wireless relay device 300 approaches the communication speed with the terminal device 100 to an appropriate value (for example, the communication speed with the base station device 200) by repeatedly increasing the number of carriers in this manner.

This means that in a case where the data equal to or greater than the threshold is retained in the downlink buffer, even though the uplink data retention amount is large, the transmission of the downlink data is preferentially performed. For example, the downlink data is data received from a terminal device belonging to the external network via the base station device 200. If the data is discarded in the wireless relay device 300, the device belonging to the external network re-transmits the discarded data, and thus, the re-transmitted data passes through many devices including the base station device 200. A case where the data passes through many devices means that the wired and wireless resources of the communication system 10 are used or processing loads of the respective devices of the communication system 10 are caused. Meanwhile, even though the uplink data is discarded in the wireless relay device 300, the data is re-transmitted from the terminal device 100, and thus, the number of devices through which the data passes is less than that in a case where the downlink data is re-transmitted. Thus, the avoidance of the retention of the downlink data within the downlink buffer is preferentially considered, and thus, it is possible to suppress the use of the wired and wireless resource of the communication system 10 and the increase of the processing loads of the respective devices of the communication system 10.

Meanwhile, in a case where the data retention ratio of the downlink buffer is not equal or greater than the downlink threshold (No in S2082), the wireless relay device 300 determines the data retention ratio of the uplink buffer (S2084). In a case where the data retention ratio of the uplink buffer is equal or greater than the uplink threshold (Yes in S2084), the wireless relay device 300 decreases the number of carriers by one (S2085). If the number of carriers is decreased, the uplink communication speed with the terminal device 100 is decreased, and the data is avoided from being further retained in the uplink buffer. Since there is no data retained (or a small amount of data is retained) in the downlink buffer of the wireless relay device 300, the data amount received in the downlink from the base station device 200 is less than the data amount transmitted to the terminal device 100 from the wireless relay device 300. Thus, the wireless relay device 300 determines that the downlink communication speed from the wireless relay device 300 to the terminal device 100 is excessively fast in transmitting the data, and decreases a retention amount of the uplink buffer by decreasing the uplink communication speed with the terminal device 100.

Similarly to the downlink threshold, the uplink threshold is set to be, for example, 50%. Similarly to the downlink threshold, the uplink threshold may be a value such that the data retention ratio does not exceed 100% even though the maximum number of data packets is received within a predetermined time based on the communication speed with the terminal device 100. The downlink threshold capable of being controlled in this manner may be notified and applied to the wireless relay device 300 from the base station device 200 during the data communication. Similarly to the case where the number of carriers is increased, in a case where the difference between the communication speed with the base station device 200 and the communication speed with the terminal device 100 is large, the wireless relay device 300 also the communication speed with the terminal device 100 to an appropriate value by repeatedly decreasing the number of carriers by one.

In a case where the data retention ratio of the uplink buffer is not equal or greater than the uplink threshold (No in S2084), the wireless relay device 300 ends the process without increasing or decreasing the number of carriers. In this case, since there is no data retained (or a small amount of data is retained) in the uplink buffer and the downlink buffer, the wireless relay device 300 determines the uplink and downlink communication speeds are appropriate.

Hereinafter, a specific example of the uplink data retention ratio and the downlink data retention ratio will be described with reference to a process flowchart of FIG. 19.

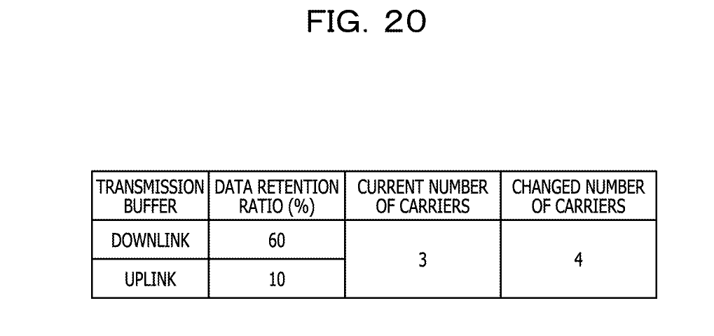

FIG. 20 is a diagram illustrating an example in a case where the downlink data retention ratio is equal or greater than the downlink threshold and the uplink data retention ratio is less than the uplink threshold. In a case where the data retention ratio of the downlink buffer is 60% and is equal or greater than 50% which is the downlink threshold (Yes in S2082), the wireless relay device 300 increases the number of carriers by one (S2083). As a result, the number of carriers in the communication with the terminal device 100 is four carriers by increasing 3 which is the current number of carriers by one carrier.

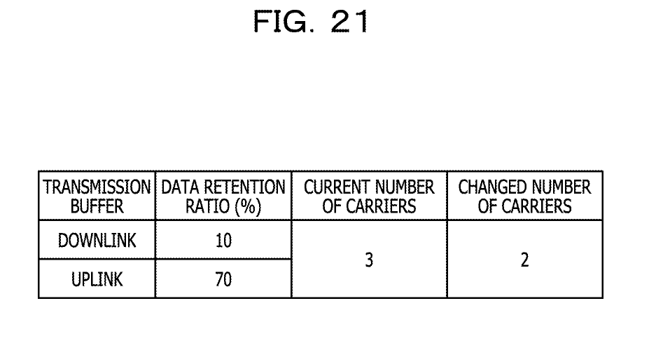

FIG. 21 is a diagram illustrating an example in a case where the downlink data retention ratio is less than the downlink threshold and the uplink data retention ratio is equal or greater than the uplink threshold. In a case where the data retention ratio of the downlink buffer is 10% and is not equal or greater than 50% which is the downlink threshold (No in S2082), since the data retention ratio of the uplink buffer is 70% and is equal or greater than 50% which is the uplink threshold (Yes in S2084), the wireless relay device 300 decreases the number of carriers by one (S2085). As a result, the number of carriers in the communication with the terminal device 100 is two carriers by decreasing 3 which is the current number of carriers by one carrier.

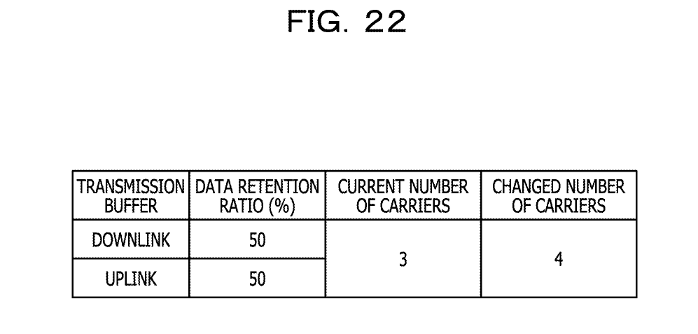

FIG. 22 is a diagram illustrating an example in a case where the downlink data retention ratio is equal or greater than the downlink threshold and the uplink data retention ratio is equal or greater than the uplink threshold. In this case, since the uplink data retention ratio is 50% and is equal or greater than 50% which is the uplink threshold but the downlink data retention ratio is 50% and is equal to or greater than 50% which is the downlink threshold (Yes in S2082), the number of carriers is increased by one irrespective of the uplink data retention amount (S2083). As a result, similarly to the case of FIG. 20, the number of carriers in the communication with the terminal device 100 is four carriers by increasing 3 which is the current number of carriers by one carrier.

In the third embodiment, the wireless relay device 300 increases or decreases the number of carriers based on the acquired uplink and downlink data retention amounts without actually measuring the communication speed. For example, the actual measurement of the communication speed is a process of normally monitoring and storing the packets transmitted and received from and by the wireless relay device 300 and calculating the communication speed based on the stored number of transmitted and received packets. The calculation of the communication speed causes a large processing load in the wireless relay device 300. In the third embodiment, the measurement of the communication speed causing the large processing load is not performed, and a process of acquiring the data retention amounts of the uplink and downlink buffers and indirectly determining the communication speed is performed. This process causes a small processing load, and thus, it is possible to control the efficient number of carriers.

### Fourth Embodiment

Hereinafter, a fourth embodiment will be described. In the fourth embodiment, a determination unit decreases the number of carriers in a case where the uplink data retention amount is greater than the downlink data retention amount, and increases the number of carriers in a case where the downlink data retention amount is greater than the uplink data retention amount.

<Carrier Number Change Process>

A sequence of a carrier determination process according to the fourth embodiment is the same as the sequence illustrated in FIG. 6. Hereinafter, the carrier determination process S205 will be described.

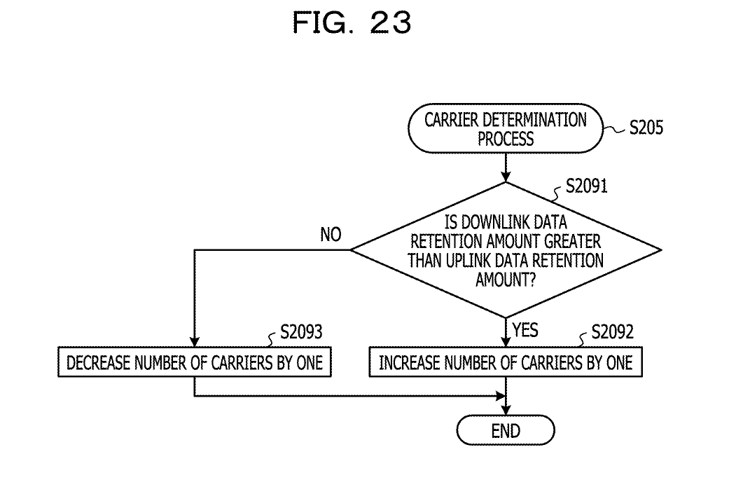

FIG. 23 is a diagram illustrating an example of a process flowchart of the carrier determination process S205. In a case where the downlink data retention amount is greater than the uplink data retention amount (Yes in S2091), the wireless relay device 300 increases the number of carriers in the communication with the terminal device 100 by one (S2092). A case where the downlink data retention amount is greater than the uplink data retention amount means that the difference (downlink communication speed difference) between the communication speed VBR and the communication speed VRM is greater than the difference (uplink communication speed difference) between the communication speed VMR and the communication speed VRB. Thus, the wireless relay device 300 increases the number of carriers such that the communication speed VRM approaches the communication speed VBR greater than the communication speed VRM, and preferentially improves the communication speed having the large communication speed difference.

Meanwhile, in a case where the uplink data retention amount is greater than the downlink data retention amount (No in S2092), the wireless relay device 300 decreases the number of carriers in the communication with the terminal device 100 by one (S2093). A case where the uplink data retention amount is greater than the downlink data retention amount means that the uplink communication speed difference is greater than the downlink communication speed difference. The wireless relay device 300 decreases the number of carriers such that the communication speed VMR approaches the communication speed VRB less than the communication speed VMR, and preferentially improves the communication speed having the communication speed difference.

Referring to the process flowchart of FIG. 23, in a case where the uplink data retention amount and the downlink data retention amount are the same (Yes in S2091), the number of carriers is decreased by one (S2093), and the downlink data is transmitted. In this manner, the downlink data retention amount may be preferentially decreased, and the number of carriers may be increased by one.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A relay device configured to perform wireless communication with a base station device and a terminal device, and to relay data transmission between the base station device and the terminal device, the relay device comprising:
a memory; and
a processor coupled to the memory and configured to:
obtain first information indicating a first communication speed in the wireless communication between the base station device and the relay device and a second communication speed in the wireless communication between the relay device and the terminal device, and
control a number of carriers to be used in the wireless communication between the relay device and the terminal device based on the first information so that the number of carriers is increased when the first communication speed is greater than the second communication speed, and the number of carriers is decreased when the second communication speed is greater than the first communication speed.

2. The relay device according to claim 1, wherein
the processor is configured to determine the number of carriers based on a difference between the first communication speed and the second communication speed.

3. The relay device according to claim 2, wherein
the processor is configured to increase or decrease the number of carriers when the difference is equal to or greater than a first value, and is configured not to increase or decrease the number of carriers when the difference is less than the first.

4. The relay device according to claim 3, wherein
the processor is configured to:
set an increase width of the number of carriers and an decrease width of the number of carriers so that the increase width and the decrease width become larger as the difference becomes larger, and
set the increase width and the decrease width so that the increase width and the decrease width become smaller as the difference becomes smaller.

5. The relay device according to claim 1, wherein
the first communication speed is a communication speed of data to be transmitted from the base station device to the relay device, and the second communication speed is a communication speed of data to be transmitted from the relay device to the terminal device.

6. The relay device according to claim 1, wherein
the first communication speed is a communication speed of data to be transmitted from the relay device to the base station device, and the second communication speed is a communication speed of data to be transmitted from the terminal device to the relay device.

7. The relay device according to claim 1, wherein
the processor is configured to:
compare a first difference between a first down link communication speed from the base station device to the relay station and a second down link communication speed from the relay device to the terminal device with a second difference between a first up link communication speed from the relay device to the base station device and a second up link communication speed from the terminal device to the relay device,
select the first down link communication speed as the first communication speed and select the second down link communication speed as the second communication speed when the first difference is greater than the second difference, and
select the first up link communication speed as the first communication speed and select the second up link communication speed as the second communication speed when the second difference is greater than the first difference.

8. The relay device according to claim 1, further comprising:
a plurality of radio frequency (RF) circuits,
wherein the processor is configured to perform the wireless communication between the relay device and the terminal device by using as many RF circuits as the number of carriers, among the plurality of RF circuits.

9. The relay device according to claim 1, wherein
the number of carriers to be used in the wireless communication is determined by the base station device.

10. The relay device according to claim 1, wherein
the processor is configured to control the terminal device to perform the wireless communication using the number of carriers.

11. The relay device according to claim 1, wherein
the processor is configured to instruct the terminal device to perform the wireless communication using the number of carriers.

12. The relay device according to claim 1, wherein
the carrier is a wireless resource including a predetermined frequency bandwidth per unit time.

13. A relay device configured to perform wireless communication with a base station device and a terminal device, and relays data transmission between the base station device and the terminal device, the relay device comprising:
a first data buffer configured to retain data to be transmitted to the terminal device;
a memory; and
a processor coupled to the memory and configured to:
obtain first information indicating a first data amount of data accumulated in the first data buffer, and
control a number of carriers to be used in the wireless communication between the relay device and the terminal device based on the first information so that the number of carriers is increased when the first data amount is equal to or greater than a first value.

14. The relay device according to claim 13, further comprising:
a second data buffer configured to store data to be transmitted to the terminal device, wherein
the first information further indicates a second data amount of data accumulated in the second data buffer, and
the processor is configured to decrease the number of carriers when the first data amount is less than the first value and the second data amount is equal to or greater than a second value.

15. The relay device according to claim 14, wherein
the first value is a ratio of the first data amount to a buffer size of the first buffer, and
the second value is a ratio of the second data amount to a buffer size of the second buffer.

16. The relay device according to claim 13, further comprising:
a second data buffer configured to store data to be transmitted to the terminal device, wherein
the first information further indicates a second data amount of data accumulated in the second data buffer, and
the processor is configured to decrease the number of carriers when the second data amount is greater than the first data amount, and to increase the number of carriers when the first data amount is greater than the second data amount.

17. A method of wireless communication executed by a relay device configured to communicate with a base station device and a terminal device, and to relay data transmission between the base station device and the terminal device, the method comprising:
obtaining first information indicating a first communication speed in the wireless communication between the base station device and the relay device and a second communication speed in the wireless communication between the relay device and the terminal device; and
controlling a number of carriers to be used in the wireless communication between the relay device and the terminal device based on the first information so that the number of carriers is increased when the first communication speed is greater than the second communication speed, and the number of carriers is decreased when the second communication speed is greater than the first communication speed.

18. The method according to claim 17, wherein
in the controlling of the number of carriers, the number of carriers is determined based on a difference between the first communication speed and the second communication speed.

19. The method according to claim 18, wherein
executing at least one of increasing and decreasing of the number of carriers when the difference is equal to or greater than a first value, and not executing the increasing and the decreasing of the number of carriers when the difference is less than the first.

20. The method according to claim 19, further comprising:
in the controlling of the number of carriers, setting an increase width of the number of carriers and an decrease width of the number of carriers so that the increase width and the decrease width become larger as the difference becomes larger, and setting the increase width and the decrease width so that the increase width and the decrease width become smaller as the difference becomes smaller.
